(19) United States
(12) Patent Application Publication
(10) Pub. No.: US 2024/0342516 A1
(43) Pub. Date: Oct. 17, 2024

(54) FIRE ESCAPE MASK

(71) Applicant: FILOS CO., LTD., Daejeon (KR)

(72) Inventor: Cheol Seung KIM, Incheon (KR)

(73) Assignee: FILOS CO., LTD., Daejeon (KR)

(21) Appl. No.: 18/501,471

(22) Filed: Nov. 3, 2023

(30) Foreign Application Priority Data
Apr. 17, 2023 (KR) 10-2023-0050104

(51) Int. Cl. A62B 18/02; A62B 18/08

(52) U.S. Cl. CPC A62B 18/02; A62B 18/08

(57) ABSTRACT

Proposed is a fire escape mask including a purification canister part configured to purify ambient air for breathing, a mask part configured to introduce and discharge the ambient air purified by the purification canister part, a hose part connected to the mask part to circulate exhaled air and inhaled air, a breathing bag part configured to collect air from which carbon dioxide contained in the exhaled air has been removed, and an oxygen supply part configured to supply oxygen to the mask part or the breathing bag part.

### CROSS REFERENCE TO RELATED APPLICATION

The present application claims priority to Korean Patent Application No. 10-2023-0050104, filed Apr. 17, 2023, the entire contents of which is incorporated herein for all purposes by this reference.

### BACKGROUND OF THE INVENTION

### Field of the Invention

The present disclosure relates to a fire escape mask and, more particularly, to a fire escape mask designed to effectively protect life from a variety of harmful gases, dust, and oxygen deficiency in the event of a fire.

### Description of the Related Art

Fire is one of the major disasters that cause deaths and property damage. In the event of a fire, exposure to harmful gases, dust, and oxygen deficiency can increase the risk of diseases such as respiratory disease, heart disease, and stroke, and thus countermeasures are needed.

In response to this, gas masks are being used to prevent the inflow of harmful gases and dust and to enable inhalation of only purified air.

Recently, Korean Patent Application Publication No. 10-2017-0114676 has disclosed a gas mask that combines a typical gas mask with a high-pressure compressed oxygen tank that can be useful even in situations where there is a lack of oxygen in the ambient air.

However, such conventional gas masks have a problem in that the capacity of oxygen supplied from an oxygen tank is limited, making it impossible to evacuate safely if the evacuation time is delayed.

### DOCUMENTS OF RELATED ART

(Patent Document 0001) Korean Patent Application Publication No. 10-2017-0114676 (Oct. 16, 2017 “GAS MASK”)

### SUMMARY OF THE INVENTION

Accordingly, the present disclosure has been made keeping in mind the above problems occurring in the related art, and the present disclosure is intended to provide a fire escape mask that, depending on fire situation, selectively allows the wearer to breathe only ambient air by means of a purification canister or to extend a breathing time by replenishing oxygen in the air from which carbon dioxide contained in exhaled air has been removed.

In order to achieve the above objective, according to an embodiment of the present disclosure, there is provided a fire escape mask including: a purification canister part configured to purify ambient air for breathing; a mask part configured to introduce and discharge the ambient air purified by the purification canister part; a hose part connected to the mask part to circulate exhaled air and inhaled air; a breathing bag part configured to collect air from which carbon dioxide contained in the exhaled air has been removed; and an oxygen supply part configured to supply oxygen to the mask part or the breathing bag part.

The fire escape mask according to the present disclosure may further include: a hood part provided with a viewing window that ensures visibility and an adjustable band for close fixation to a user's face.

The purification canister part may include a stopper in a center thereof that blocks ambient air.

The hose part may include a carbon dioxide absorbent that removes carbon dioxide in an inner center thereof, and a moisture remover that removes moisture at a bottom thereof.

The oxygen supply part may consistently supply, by means of a regulator coupled to an oxygen can (C), high-pressure oxygen through a hose in an amount that a user can breathe.

When breathing the ambient air, oxygen supply from an oxygen can may be cut off by means of a regulator of the oxygen supply part and breathing may be done by means of the purification canister part; when breathing through the breathing bag part, breathing may be done by replenishing oxygen of the oxygen can to air from which carbon dioxide contained in the exhaled air has been removed by adjusting the regulator of the oxygen supply part after blocking the ambient air by closing the purification canister part with a stopper.

According to the present disclosure, safe evacuation is possible since, depending on fire situation, the wearer can breathe ambient air by means of a purification canister, or when breathing ambient air is difficult, a breathing time can be extended by replenishing oxygen in the air from which carbon dioxide contained in exhaled air has been removed.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is an example showing wearing a fire escape mask according to the present disclosure; and

FIG. 2 is a configuration diagram showing the fire escape mask according to the present disclosure.

### DETAILED DESCRIPTION OF THE INVENTION

Hereinafter, preferred embodiments of the present disclosure will be described in detail with reference to the accompanying drawings, so that those skilled in the art can easily implement the present disclosure. However, the present disclosure may be implemented in many different forms and is not limited to the embodiments described herein.

A preferred embodiment of a fire escape mask according to the present disclosure will be described in detail.

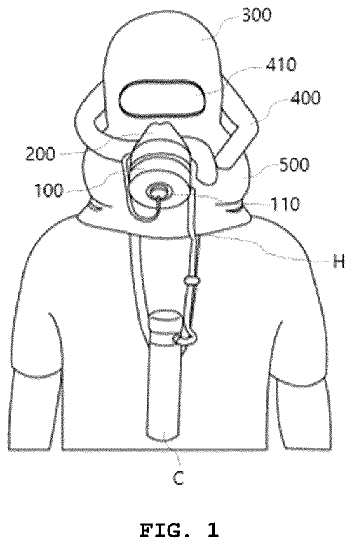

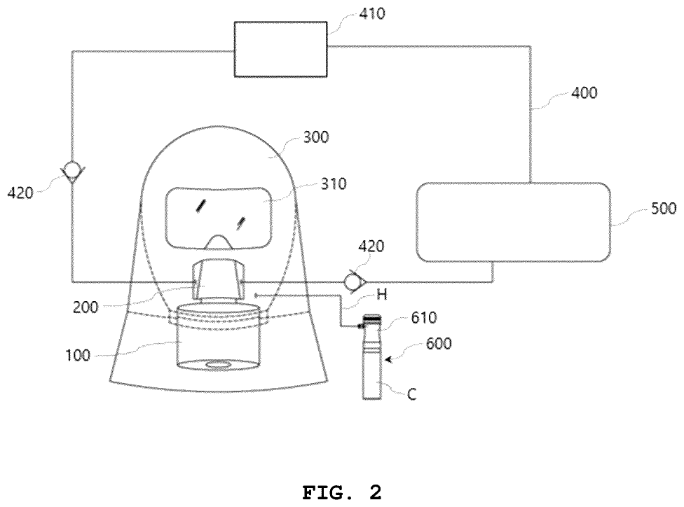

FIG. 1 is an example showing wearing a fire escape mask according to the present disclosure; and FIG. 2 is a configuration diagram showing the fire escape mask according to the present disclosure.

Referring to FIGS. 1 and 2, fire escape mask according to the present disclosure may include a purification canister part 100, a mask part 200, a hood part 300, a hose part 400, a breathing bag part 500, and an oxygen supply part 600.

The purification canister part 100 may be provided with a filter to purify ambient air. In this case, a removable stopper 110 that blocks ambient air is provided at the center of the purification canister part 100, allowing a user to selectively breath ambient air.

The mask part 200 may introduce and discharge the ambient air purified by the purification canister part 100. That is, the mask part 200 may prevent inhalation of harmful gases by means of the purification canister part 100, and introduce and discharge air to enable breathing.

In addition, the mask part 200 may be formed such that the lower center of the hood part 300 is cut so that an inlet provided at that cut portion faces the inside of the hood part 300.

The hood part 300 may include a viewing window 310 to ensure visibility and an adjustment band (not shown) that may be tightly fixed to a user's face.

The hose part 400 may circulate exhaled air and inhaled air. In this case, in the hose part 400, a hose is connected to one side of the mask part 200 and the breathing bag part 500 that collects air from which carbon dioxide contained in exhaled air has been removed, and another hose may be connected to the other side of the mask part 200 and the breathing bag part 500.

Inside the hose part 400, a carbon dioxide absorbent 410 that removes carbon dioxide exhaled; a moisture remover (not shown) that removes moisture released during exhalation; and a check valve 420 that opens in only one direction during exhalation and inhalation.

At this time, the carbon dioxide absorbent 410 is made of calcium hydroxide and may be provided in the center of the hose part 400, and the moisture remover is made of zeolite and maybe provided at the bottom of the hose part 400, but is not limited thereto.

The breathing bag part 500 may collect air contained in the mask part 200 when exhaling. That is, the breathing bag part 500 may collect air from which carbon dioxide contained in exhaled air in the mask part 200 is removed through the carbon dioxide absorbent 410 of the hose unit 400.

As an example, oxygen supplied from the oxygen supply part 600 may be supplemented to the breathing bag part 500 that collects air from which carbon dioxide exhaled in the mask part 200 is removed by means of the carbon dioxide absorbent 410 of the hose unit 400, and supplied as breathing air in the mask part 200.

The oxygen supply part 600 may, using a regulator 610 coupled to an oxygen can C, consistently supply high-pressure oxygen through a hose H in an amount that the user may breathe. At this time, the hose H has one side thereof connected to the oxygen supply part 600 and the other side thereof connected to the breathing bag part 500 or mask part 200 to supply oxygen.

In the present disclosure, when breathing ambient air, the wearer or user may only breathe by means of the purification canister part 100 without using the oxygen supply part 600. That is, when breathing ambient air in a place with an appropriate oxygen concentration (more than 18%) and a low toxic gas concentration (breathable level), the wearer or user may block the oxygen supply from the oxygen can C using the regulator 610 of the oxygen supply part 600 and breathe ambient air by means of the purification canister part 100.

Meanwhile, in the present disclosure, when it is difficult to breathe ambient air, the wearer or user may breathe by means of the breathing bag part 500. In this case, without using the purification canister part 100, it is possible to breathe by supplementing oxygen with the air from which carbon dioxide contained in exhaled air has been removed.

For example, when breathing through the breathing bag part 500, the wearer or user may breathe by replenishing the oxygen of the oxygen can C to the air from which carbon dioxide contained in exhaled air has been removed by adjusting the regulator 610 of the oxygen supply part 600 after blocking the ambient air by closing the purification canister part 100 with the stopper.

As described above, according to the present disclosure, since the wearer or user may breathe ambient air or breathe by replenishing oxygen to the air from which carbon dioxide contained in exhaled air has been removed, a breathing time may be extended to enable safe evacuation.

Although the embodiments of the present disclosure have been described in detail above, the scope of the present disclosure is not limited thereto, various modifications and improvements made by those skilled in the art using the basic concept of the present disclosure defined in the following claims also fall within the scope of the present disclosure.

What is claimed is:

1. A fire escape mask, comprising:
a purification canister part configured to purify ambient air for breathing;
a mask part configured to introduce and discharge the ambient air purified by the purification canister part;
a hose part connected to the mask part to circulate exhaled air and inhaled air;
a breathing bag part configured to collect air from which carbon dioxide contained in the exhaled air has been removed; and
an oxygen supply part configured to supply oxygen to the mask part or the breathing bag part.

2. The fire escape mask of claim 1, further comprising:
a hood part provided with a viewing window that ensures visibility and an adjustable band for close fixation to a user's face.

3. The fire escape mask of claim 1, wherein the purification canister part comprises a stopper in a center thereof that blocks ambient air.

4. The fire escape mask of claim 1, wherein the hose part comprises a carbon dioxide absorbent that removes carbon dioxide in an inner center thereof, and a moisture remover that removes moisture at a bottom thereof.

5. The fire escape mask of claim 1, wherein the oxygen supply part consistently supplies, by means of a regulator coupled to an oxygen can (C), high-pressure oxygen through a hose in an amount that a user can breathe.

6. The fire escape mask of claim 1, wherein when breathing the ambient air, oxygen supply from an oxygen can is cut off by means of a regulator of the oxygen supply part and breathing is done by means of the purification canister part; when breathing through the breathing bag part, breathing is done by replenishing oxygen of the oxygen can to air from which carbon dioxide contained in the exhaled air has been removed by adjusting the regulator of the oxygen supply part after blocking the ambient air by closing the purification canister part with a stopper.
